(19) United States
(12) Patent Application Publication
(10) Pub. No.: US 2025/0294597 A1
(43) Pub. Date: Sep. 18, 2025

(54) METHOD AND APPARATUS FOR DETERMINING RESOURCE, AND STORAGE MEDIUM

(71) Applicant: Beijing Xiaomi Mobile Software Co., Ltd., Beijing (CN)

(72) Inventors: Qun ZHAO, Beijing (CN); Wensu ZHAO, Beijing (CN)

(21) Appl. No.: 18/859,968

(22) PCT Filed: Apr. 29, 2022
(86) PCT No.: PCT/CN2022/090524

§ 371 Date: Oct. 24, 2024

(51) Int. Cl. H04W 72/40; H04W 72/02; H04W 72/0446; H04W 72/0453; H04W 72/25

(52) U.S. Cl. CPC H04W 72/40; H04W 72/02; H04W 72/0446; H04W 72/0453; H04W 72/25

(57) ABSTRACT

A method for determining a resource, includes: receiving sidelink control information, the sidelink control information indicating a first time-frequency resource; and based on the sidelink control information, determining a candidate time-frequency resource to be excluded, where the candidate time-frequency resource to be excluded includes a candidate time-frequency resource that has resource coincidence with a second time-frequency resource, the second time-frequency resource has resource coincidence with the first time-frequency resource in a time domain, and has a different resource position from the first time-frequency resource in a frequency domain.

### CROSS-REFERENCE

The present application is a U.S. National Stage of International Application No. PCT/CN2022/090524, filed on Apr. 29, 2022, the contents of all of which are incorporated herein by reference in their entirety for all purposes.

### BACKGROUND OF THE INVENTION

With the constant emergence of a new generation of new Internet applications, higher requirements are put forward for a wireless communication technology, driving the continuous evolution of the wireless communication technology to meet the needs of the applications. 5G New Radio (NR) supports communication between terminals via a sidelink (SL, also known as direct link) in Release (Rel) 16, which is later enhanced in Rel17.

### SUMMARY OF THE INVENTION

The disclosure relates to the technical field of wireless communications, in particular to a method and apparatus for determining a resource, and a storage medium.

In view of this, the disclosure provides a method and apparatus for determining a resource, and a storage medium.

According to a first aspect of an example of the disclosure, a method for determining a resource is provided, performed by user device, the method including:
receiving sidelink control information, the sidelink control information indicating a first time-frequency resource; and
determining a candidate time-frequency resource to be excluded based on the sidelink control information,
where the candidate time-frequency resource to be excluded includes a candidate time-frequency resource that has resource overlap with a second time-frequency resource, and the second time-frequency resource has resource overlap with the first time-frequency resource in a time domain, and has a different resource position from the first time-frequency resource in a frequency domain.

According to a second aspect of an example of the disclosure, a communication apparatus is provided, including:
a processor; and
a memory used to store processor-executable instructions, where
the executable instructions stored in the memory, when executed by the processor, cause the processor to perform:
receiving sidelink control information, the sidelink control information indicating a first time-frequency resource; and
determining a candidate time-frequency resource to be excluded based on the sidelink control information;
where the candidate time-frequency resource to be excluded comprises a candidate time-frequency resource that has resource overlap with a second time-frequency resource, and the second time-frequency resource has resource overlap with the first time-frequency resource in a time domain, and has a different resource position from the first time-frequency resource in a frequency domain.

According to a third aspect of an example of the disclosure, a non-transitory computer-readable storage medium is provided, storing one or more programs configured to be executed by one or more processors of processing device, the one or more programs comprising instructions which, when executed by the processing device, causes the processing device to perform:
receiving sidelink control information, the sidelink control information indicating a first time-frequency resource; and
determining a candidate time-frequency resource to be excluded based on the sidelink control information;
where the candidate time-frequency resource to be excluded comprises a candidate time-frequency resource that has resource overlap with a second time-frequency resource, and the second time-frequency resource has resource overlap with the first time-frequency resource in a time domain, and has a different resource position from the first time-frequency resource in a frequency domain

It is understandable that the above general descriptions and later detailed descriptions are merely examples and illustrations, and cannot limit the disclosure.

### BRIEF DESCRIPTION OF DRAWINGS

The accompanying drawings are included here to provide a further understanding of examples of the disclosure and constitute a part of the present application. The examples of the examples of the disclosure and the description of the examples are used for explaining the examples of the disclosure and do not constitute an undue limitation to the examples of the disclosure. In the accompanying drawings:
the accompanying drawings here, which are incorporated in and constitute a part of the specification, illustrate examples consistent with the examples of the disclosure and together with the specification serve to explain the principles of the examples of the disclosure.

FIG. 1 is a schematic structural diagram of a wireless communication system provided by an example of the disclosure.

FIG. 2 is a schematic diagram of interference caused by in-band emission.

FIG. 3 is a flowchart of a method for determining a resource according to an example.

FIG. 4 is a schematic diagram of inter-UE interference.

FIG. 5 is a flowchart of a method for determining a resource according to an example.

FIG. 6 is a block diagram of an apparatus for determining a resource according to an example.

FIG. 7 is a structural diagram of an apparatus for determining a resource according to an example.

### DETAILED DESCRIPTION OF THE INVENTION

The examples of the disclosure will now be further illustrated with reference to the accompanying drawings and the detailed description.

Examples will be described in detail here, examples of which are illustrated in the accompanying drawings. When the following description refers to the accompanying drawings, unless otherwise indicated, the same numerals in different accompanying drawings indicate the same or similar elements. The implementations described in the following examples do not represent all implementations consistent with the examples of the disclosure. Rather, they are merely instances of apparatuses and methods consistent with some aspects of the disclosure as detailed in the appended claims.

The terms used in the examples of the disclosure are merely for the purpose of describing specific examples, and are not intended to limit the examples of the disclosure. The singular forms “one” and “the” used in the examples of the disclosure and the appended claims are also intended to include the majority forms unless the context clearly indicates other meanings. It is further understandable that the term “and/or” as used here refers to and includes any or all possible combinations of one or more associated listed items.

It is understandable that although the terms first, second, third, etc. may be used to describe various information in the examples of the disclosure, such information is not limited to these terms. These terms are merely used to distinguish the same type of information from each other. For example, without departing from the scope of the examples of the disclosure, first information may also be referred to as second information, and similarly, the second information may also be referred to as the first information. Depending on the context, the words “if” and “in a case that” as used here may be interpreted as “at the time of” or “when” or “in response to determining that”.

The examples of the disclosure will be described below in detail, examples of which are illustrated in the accompanying drawings. The same or similar reference numerals refer to the same or similar elements throughout. The examples described below with reference to the accompanying drawings are examples, and are intended to be used to be illustrative of the disclosure and are not construed as limiting the disclosure.

With the constant emergence of a new generation of new Internet applications, higher requirements are put forward for a wireless communication technology, driving the continuous evolution of the wireless communication technology to meet the needs of the applications. 5G New Radio (NR) supports communication between terminals via a sidelink (SL, also known as direct link) in Release (Rel) 16, which is later enhanced in Rel17. However, spectra used for sidelink communication in Rel16 and Rel7 merely consider the licensed spectrum and the dedicated spectrum, and there is no support for sidelink communication in the shared spectrum (shared spectrum). However, sidelink communication in the shared spectrum needs to meet the occupied bandwidth (OCB) requirement stipulated by the regulations. For example, regulations in some regions require that when terminals use a certain shared spectrum for data transmission, the occupied bandwidth (bandwidth containing 99% of the signal power) needs to reach 80% to 100% of the nominal bandwidth.

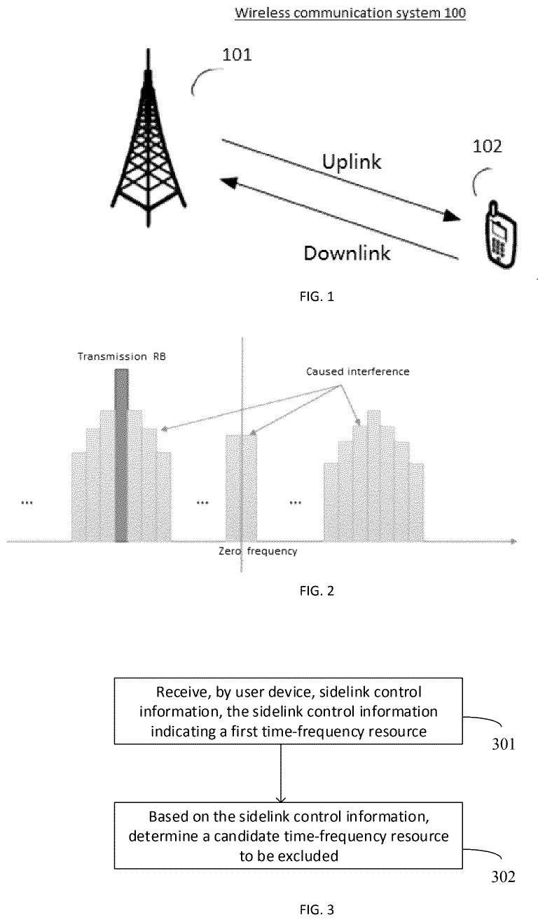

As shown in FIG. 1, a method for determining a resource provided by an example of the disclosure may be applied to a wireless communication system 100, and the wireless communication system 100 may include, but is not limited to, network device 101 and user device 102. The user device 102 is configured to support carrier aggregation, and the user device 102 including a plurality of carrier units that may be connected to the network device 101, for example, the carrier units including a primary carrier unit and one or more secondary carrier units.

It is understandable that the above wireless communication system 100 can be applied to both low-frequency scenarios and high-frequency scenarios. Application scenarios for the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-Generation (5G) system, a new radio (NR) communication system or a future evolved public land mobile network (PLMN) system, etc.

The user device 102 shown above may be user device (UE), a terminal, an access terminal, a terminal unit, a terminal station, a mobile station (MS), a remote station, a remote terminal, a mobile terminal, wireless communication device, a terminal agent or user device, etc. The user device 102 may have a wireless transceiver function and is capable of communicating (e.g. wirelessly communicating) with one or more network device 101 of one or more communication systems and receiving network services provided by the network device 101, and the network device 101 here includes, but is not limited to, a base station shown in the figure.

The user device 102 may be a cellular phone, a cordless phone, a session initiation protocol (SIP) phone, a wireless local loop (WLL) station, personal digital assistant (PDA) device, handheld device with a wireless communication function, computing device or other processing device connected to a wireless modem, on-board device, wearable device, user device in future 5G networks or user device in future evolved PLMN networks, etc.

The network device 101 may be access network device (or an access network site). The access network device refers to device providing a network access function, such as a radio access network (RAN) base station. The network device may specifically include base station (BS) device, or include base station device and radio resource management device used to control the base station device, etc. The network device may further include a relay station (relay device), an access point, a base station in future 5G networks, a base station in future evolved PLMN networks, or an NR base station, etc. The network device may be wearable device or on-board device. The network device may also be a communication chip having a communication module.

For example, the network device 101 includes, but is not limited to, gnodeB (gNB) in 5G, evolved node B (eNB) in the LTE system, a radio network controller (RNC), node B (NB) in a WCDMA system, a wireless controller under the CRAN system, a base station controller (BSC), a base transceiver station (BTS) in a GSM system or CDMA system, home base stations (e.g., home evolved nodeB, or home node B (HNB)), a baseband unit (BBU), a transmitting and receiving point (TRP), a transmitting point (TP) or a mobile switching center, etc.

In NRRel16, in order to support NR working in a shared spectrum, the concept of an interlaced resource block (IRB) is defined to meet the OCB requirement of the regulations. For a 20 MHz shared subband, in case that a subcarrier spacing is 15 KHz, one IRB contains 10 discontinuous PRBs; 10 PRBs are fixedly spaced apart between two adjacent PRBs in the same IRB; and there are 10 IRBs on the 20 MHz subband, which are IRB 0, 1, . . . , 9 according to the frequency sequence. If the subcarrier spacing is 30 KHz, one IRB contains 10 discontinuous PRBs; 5 PRBs are spaced apart between two adjacent PRBs in the same IRB; and there are 5 IRBs on the 20 MHz subband, which are 0, 1, 2, 3, and 4 respectively according to the frequency sequence. If the terminal uses the IRB for data transmission, the OCB requirements can be met.

On the other hand, due to the nonlinear nature of a transmitter of transmitting device, in-band emission will be caused. A common model of in-band emission is shown in FIG. 2. According to the different frequency resource positions used by the transmitting device, the interference intensities at different frequency positions in a band are also different. In sidelink communication, due to the arbitrariness of the position between different transmitting terminals and receiving terminals, the receiving power difference between an interference signal and a useful signal may be large. In this case, even if the interference signal and the useful signal use mutually orthogonal frequency resources, it may cause strong interference due to the influence of in-band emission.

Thus, the user device needs to minimize the interference caused by in-band emission when determining a candidate time-frequency resource of the user device.

An example of the disclosure provides a method for determining a resource. FIG. 3 is a flowchart of a method for determining a resource according to an example. As shown in FIG. 3, the method includes steps 301 and 302.

In step 301, sidelink control information is received by user device, the sidelink control information indicating a first time-frequency resource.

For example, a first user device receives sidelink control information (SCI) from a second user device, the sidelink control information indicating the first time-frequency resource used by the second user device. The first time-frequency resource may be a time-frequency resource on a slot in a resource selection window, for example, a time-frequency resource m in a slot n.

For example, resource indication information in the SCI indicates the first time-frequency resource, or resource reservation information in the SCI indicates the first time-frequency resource.

Step 302, based on the sidelink control information, a candidate time-frequency resource to be excluded is determined.

In order to prevent interference caused by in-band emission, the first user device excludes the time-frequency resource that may cause greater interference from available candidate time-frequency resources of the first user device. The candidate time-frequency resource to be excluded includes a candidate time-frequency resource that has resource overlap with a second time-frequency resource, and the second time-frequency resource has resource overlap with the first time-frequency resource in a time domain, and has a different resource position from the first time-frequency resource in a frequency domain. The resource overlap here refers to the resource overlap in both the frequency domain and the time domain. Hence, the second time-frequency resource is a time-frequency resource different from the first time-frequency resource.

By excluding the candidate time-frequency resource that has resource overlap with the second time-frequency resource from the available candidate time-frequency resources of the user device, the interference caused by the in-band emission can be reduced as much as possible.

The technical solution provided by the examples of the disclosure may include the following beneficial effects: in order to prevent interference caused by in-band emission, the user device excludes the time-frequency resource that may cause greater interference from available candidate time-frequency resources of the user device, that is, excludes the candidate time-frequency resource that has resource overlap with the second time-frequency resource. Since the second time-frequency resource is not the same time-frequency resource as the first time-frequency resource used by other user device, that is, more candidate time-frequency resources that may cause interference are excluded, the interference caused by the in-band emission can be reduced to a greater extent.

In one implementation of the disclosure, the candidate time-frequency resource to be excluded further includes a candidate time-frequency resource that has resource overlap with the first time-frequency resource. It can be seen from the above that the first time-frequency resource is a time-frequency resource indicated in the SCI sent by the second user device and used by the second user device. Thus, the candidate time-frequency resource that has resource overlap with the first time-frequency resource is excluded to effectively prevent the interference caused by the in-band emission.

In one implementation of the disclosure, the second time-frequency resource includes at least one of the following:
a frequency-domain resource adjacent to the first time-frequency resource in the frequency domain; or
a frequency-domain resource at a mirror position of the first time-frequency resource in the frequency domain.

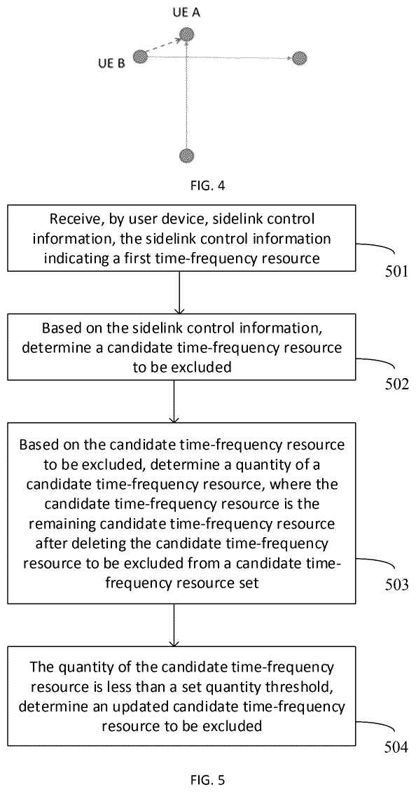

In general, in-band emission on frequency resources occupied by given transmission, frequency resources at the adjacent position, and frequency resources at the zero frequency position and the mirror position is larger. For signals transmitted by using interlaced resource blocks, because the frequency resources multiplexed by different user device are relatively close to each other, interference caused by in-band emission is stronger than that of continuous spectrum transmission, which is more likely to result in strong signals drowning weak signals at other frequency positions. FIG. 4 shows the case of the strong interference of UE A by UE B.

Thus, in order to avoid the interference caused by the in-band emission, frequency-domain resources at the adjacent position and/or the mirror position of the first time-frequency resource in the frequency domain need to be excluded. That is, the second time-frequency resource includes a frequency-domain resource adjacent to the first time-frequency resource in the frequency domain, or, the second time-frequency resource includes a frequency-domain resource at the mirror position of the first time-frequency resource in the frequency domain, or, the second time-frequency resource includes a frequency-domain resource adjacent to the first time-frequency resource in the frequency domain and a frequency-domain resource at the mirror position of the first time-frequency resource in the frequency domain.

For example, the above frequency-domain resource includes PRBs, subchannels, and IRBs.

In one implementation of the disclosure, the user device obtains a sidelink measurement value corresponding to the SCI monitored by the user device, and determines the candidate time-frequency resource to be excluded that has resource overlap with the second time-frequency resource according to the sidelink measurement value and a first threshold value.

Here, the sidelink measurement value corresponding to the SCI monitored by the user device refers to a measurement value obtained after the user device performs Sidelink measurement according to the received SCI.

For example, the above sidelink measurement value is a sidelink-reference signal receiving power (S-RSRP) measurement value or a received signal indication (RSSI) measurement value. The sidelink-reference signal receiving power may be obtained based on measurement of a demodulation reference signal (DMRS) of a physical sidelink control channel (PSCCH), and may also be obtained based on measurement of a DMRS of a physical sidelink shared channel (PSSCH).

When the sidelink measurement value obtained by the user device is greater than the first threshold value, the user device determines that the candidate time-frequency resource to be excluded includes the candidate time-frequency resource that has resource overlap with the second time-frequency resource. When the sidelink measurement value obtained by the user device is greater than a second threshold value, the user device determines that the candidate time-frequency resource to be excluded includes the candidate time-frequency resource that has resource overlap with the first time-frequency resource. The first threshold value is greater than the second threshold value.

The method for determining the candidate time-frequency resource to be excluded above is described as follows:
in a case that the sidelink measurement value obtained by the first user device is greater than a small threshold value, that is, the second threshold value, it indicates that the sidelink measurement value is small, for example, the S-RSRP measurement value or the RSSI measurement value is small. In this case, the time-frequency resource used by the first user device do not have resource overlap with the first time-frequency resource used by the second user device so as to avoid interference. In a case that the sidelink measurement value obtained by the first user device is greater than a large threshold value, that is, the first threshold value, it indicates that the sidelink measurement value is large, for example, the S-RSRP measurement value or the RSSI measurement value is large. In this case, the time-frequency resource used by the first user device may cause interference even if it does not have resource overlap with the first time-frequency resource used by the second user device. Thus, it is necessary to exclude more candidate time-frequency resources from a candidate time-frequency resource set of the first user device, such as frequency resources at the adjacent position or the mirror position of the first time-frequency resource in the frequency domain.

For example, the first threshold value is equal to the second threshold value plus a set offset value.

In one implementation of the disclosure, the first threshold value is determined based on one of the following:
pre-defining the first threshold value;
pre-configuring the first threshold value; and
determining the first threshold value based on configuration or indication of a downlink signaling from network device.

An example of the disclosure provides a method for determining a resource. FIG. 5 is a flowchart of a method for determining a resource according to an example. As shown in FIG. 5, the method includes steps 501, 502, 503 and 504.

In step 501, sidelink control information is received by user device, the sidelink control information indicating a first time-frequency resource.

In step 502, based on the sidelink control information, a candidate time-frequency resource to be excluded is determined.

In step 503, based on the candidate time-frequency resource to be excluded, a quantity of a candidate time-frequency resource is determined, and the candidate time-frequency resource is the remaining candidate time-frequency resource after deleting the candidate time-frequency resource to be excluded from a candidate time-frequency resource set.

In step 504, the quantity of the candidate time-frequency resource is less than a set quantity threshold, an updated candidate time-frequency resource to be excluded is determined.

The candidate time-frequency resource in the steps 503 and 504 is the target candidate time-frequency resource.

In the above implementation, the first user device receives SCI from the second user device, the SCI indicating a first time-frequency resource used by the second user device. The first user device obtains a sidelink measurement value corresponding to the SCI monitored by the first user device. When the sidelink measurement value is greater than a first threshold value, it is determined that the candidate time-frequency resource to be excluded includes a candidate time-frequency resource that has resource overlap with a second time-frequency resource and a candidate time-frequency resource that has resource overlap with the first time-frequency resource. The first user device deletes the above candidate time-frequency resource to be excluded from the candidate time-frequency resource set to obtain the target candidate time-frequency resource. When the target candidate time-frequency resource obtained by using the above method are used for sidelink communication, interference caused by in-band emission can be better avoided. However, if the quantity of the candidate time-frequency resource obtained after deleting the candidate time-frequency resource to be excluded is too small, the usage of time-frequency resources by the first user device will be affected. Thus, if the quantity of the above target candidate time-frequency resources is less than the set quantity threshold, it is necessary to update the candidate time-frequency resource to be excluded, that is, to reduce part of the candidate time-frequency resource to be excluded to increase the quantity of the candidate time-frequency resource available to the first user device. The set quantity threshold here may be pre-defined, pre-configured, or configured by network device.

In one implementation of the disclosure, the following method may be adopted to determine the updated candidate time-frequency resource to be excluded:
successively increasing the first threshold value by a set step size, in a case that the sidelink measurement value is greater than the increased first threshold value, determining the updated candidate time-frequency resource to be excluded, and determining the quantity of the target candidate time-frequency resources based on the updated candidate time-frequency resource to be excluded until the quantity of the target candidate time-frequency resource is greater than or equal to the set quantity threshold.

For example, the first threshold value is increased by L DBs, then the candidate time-frequency resource to be excluded is determined again according to the method shown in FIG. 3, and the above redetermined candidate time-frequency resource to be excluded is deleted from the candidate time-frequency resource set to obtain the target candidate time-frequency resource. If the quantity of the target candidate time-frequency resource at this time is greater than or equal to the set quantity threshold, the candidate time-frequency resource to be excluded that is redetermined at this time is the updated candidate time-frequency resource to be excluded. If the quantity of the target candidate time-frequency resource at this time is still less than the set quantity threshold, the first threshold value continues to be increased by L DBs, and the above operation is repeated until the quantity of the target candidate time-frequency resources determined based on the redetermined candidate time-frequency resource to be excluded is greater than or equal to the set quantity threshold.

In one implementation of the disclosure, the following method may be adopted to determine the updated candidate time-frequency resource to be excluded:
determining that the updated candidate time-frequency resource to be excluded merely includes the candidate time-frequency resource that has resource overlap with the first time-frequency resource.

For example, the first threshold value is increased to positive infinity, and there is no second time-frequency resource in this case. Thus, the candidate time-frequency resource to be excluded merely includes the candidate time-frequency resource that has resource overlap with the first time-frequency resource.

For example, the second time-frequency resource is set to be an empty set, and in this case, the candidate time-frequency resource to be excluded merely includes the candidate time-frequency resource that has resource overlap with the first time-frequency resource.

Or, when the candidate time-frequency resource to be excluded is deleted from the candidate time-frequency resource set, the candidate time-frequency resource that has resource overlap with the second time-frequency resource is not deleted. The candidate time-frequency resource obtained by this way is equal to the candidate time-frequency resource obtained by setting the second time-frequency resource as the empty set.

An example of the disclosure provides a method for determining a resource. The method includes:
receiving, by user device, sidelink control information, the sidelink control information indicating a first time-frequency resource; and performing, by the user device, resource selection or resource reselection of a time-frequency resource for sidelink data transmission to determine a candidate time-frequency resource to be excluded based on the sidelink control information.

It is noted that the following two operation steps a) and b) of the user device in the above method can be performed interchangeably in sequence: a) receiving the sidelink control information; and b) performing resource selection or resource reselection of the time-frequency resource for sidelink data transmission.

An example of the disclosure provides a method for determining a resource. The method includes:
receiving, by user device, sidelink control information, the sidelink control information indicating a first time-frequency resource; and performing, by the user device, inter-UE coordination (IUC) and determining a preferred or non-preferred resource set indicated by IUC information, to determine a candidate time-frequency resource to be excluded based on the sidelink control information.

It is noted that the following two operation steps c) and d) of the user device in the above method can be performed interchangeably in sequence: c) receiving the sidelink control information; and d) performing the IUC and determining the preferred or non-preferred resource set indicated by the IUC information.

An example of the disclosure provides a method for determining a resource. The method includes:
receiving, by user device, sidelink control information, the sidelink control

information indicating a first time-frequency resource; and performing, by the user device, sidelink data transmission in a shared spectrum by using an interlaced resource block, to determine a candidate time-frequency resource to be excluded based on the sidelink control information.

It is noted that the following two operation steps e) and f) of the user device in the above method can be performed interchangeably in sequence: e) receiving the sidelink control information; and f) performing sidelink data transmission in the shared spectrum by using the interlaced resource block.

Based on the same concept as the above method implementations, an example of the disclosure further provides an apparatus for determining a resource, and the apparatus for determining the resource may have the function of the user device in the above method implementations and is used to perform the steps provided by the above implementations and performed by the network device. This function may be implemented by software, or may be implemented by software or hardware executing corresponding software. The hardware or software includes one or more modules corresponding to the above function.

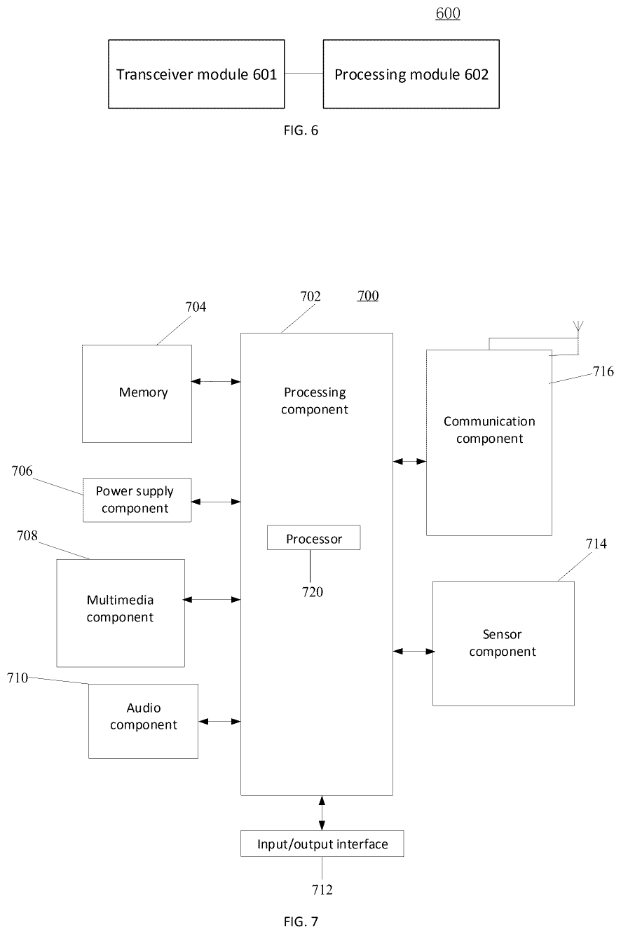

In one possible implementation, the apparatus 600 for determining the resource shown in FIG. 6 can act as the user device involved in the above method implementations and perform the steps performed by the user device in the above method implementations. As shown in FIG. 6, the apparatus 600 for determining the resource may include a transceiver module 601 and a processing module 602, which are coupled to each other. The transceiver module 601 may be used to support the communication apparatus 600 for communication, and the transceiver module 601 may have a wireless communication function, such as being able to communicate wirelessly with other communication apparatuses through wireless air interfaces. The processing module 602 may be used to support the apparatus 600 for determining the resource to perform the processing actions in the above method examples, including but not limited to: generating information and messages transmitted by the transceiver module 601, and/or performing demodulation and decoding on signals received by the transceiver module 601, etc.

When the steps implemented by the user device are executed, the transceiver module 601 is configured to receive sidelink control information, the sidelink control information indicating a first time-frequency resource; and the processing module 602 is configured to, based on the sidelink control information, determine a candidate time-frequency resource to be excluded, where the candidate time-frequency resource to be excluded includes a candidate time-frequency resource that has resource overlap with a second time-frequency resource, and the second time-frequency resource has resource overlap with the first time-frequency resource in a time domain, and has a different resource position from the first time-frequency resource in a frequency domain.

In some possible implementations, the candidate time-frequency resource to be excluded further includes a candidate time-frequency resource that has resource overlap with the first time-frequency resource.

In some possible implementations, the second time-frequency resource includes at least one of the following:
a frequency-domain resource adjacent to the first time-frequency resource in the frequency domain; or
a frequency-domain resource at a mirror position of the first time-frequency resource

in the frequency domain.

In some possible implementations, the processing module 602 is configured to:
acquire a sidelink measurement value corresponding to the sidelink control information; and
determine the candidate time-frequency resource to be excluded that has resource overlap with the second time-frequency resource according to the sidelink measurement value and a first threshold value.

In some possible implementations, the first threshold value is greater than a second threshold value,
where the candidate time-frequency resource to be excluded that has resource overlap with the first time-frequency resource is determined according to the sidelink measurement value and the second threshold value.

In some possible implementations, the first threshold value is determined based on one of the following:
pre-defining the first threshold value;
pre-configuring the first threshold value; and
determining the first threshold value based on configuration or indication of a downlink signaling from network device.

In some possible implementations, the sidelink measurement value is a sidelink-reference signal receiving power (S-RSRP) measurement value or a received signal indication (RSSI) measurement value.

In some possible implementations, the processing module 602 is further configured to:
based on the candidate time-frequency resource to be excluded, determine a quantity of a target candidate time-frequency resource, where the target candidate time-frequency resource includes the remaining candidate time-frequency resource after deleting the candidate time-frequency resource to be excluded from a candidate time-frequency resource set; and
in a case that the quantity of the target candidate time-frequency resources is less than a set quantity threshold, determine an updated candidate time-frequency resource to be excluded.

In some possible implementations, the processing module 602 is further configured to:
successively increase the first threshold value by a set step size, in a case that the sidelink measurement value is greater than an increased first threshold value, determine the updated candidate time-frequency resource to be excluded, and determine the quantity of target candidate time-frequency resources based on the updated candidate time-frequency resource to be excluded until the quantity of the target candidate time-frequency resource is greater than or equal to the set quantity threshold.

In some possible implementations, the processing module 602 is further configured to:
determine that the updated candidate time-frequency resource to be excluded merely includes the candidate time-frequency resource that has resource overlap with the first time-frequency resource.

In some possible implementations, the processing module 602 is configured to:
perform, by the user device, resource selection or resource reselection of a time-frequency resource for sidelink data transmission to determine the candidate time-frequency resource to be excluded.

In some possible implementations, the processing module 602 is configured to:
perform, by the user device, inter-UE coordination (IUC) and determine a preferred or non-preferred resource set indicated by IUC information, to determine the candidate time-frequency resource to be excluded.

In some possible implementations, the processing module 602 is configured to:
perform, by the user device, sidelink data transmission in a shared spectrum by using an interlaced resource block, to determine the candidate time-frequency resource to be excluded.

In some possible implementations, resource indication information or resource reservation information in the sidelink control information indicates the first time-frequency resource.

Based on the same concept as the above method implementations, an example of the disclosure further provides a communication apparatus, including:
a processor; and
a memory used to store processor-executable instructions, where
the processor is configured to implement steps of the method for determining the resource described above by executing the executable instructions in the memory.

When the apparatus for determining the resource is user device, the structure of the apparatus may also be shown as an apparatus 700. For example, the apparatus 700 may be a mobile phone, a computer, a digital broadcasting terminal, messaging device, a game console, tablet device, medical device, fitness device, a personal digital assistant, etc.

Referring to FIG. 7, the apparatus 700 may include one or more of the following components: a processing component 702, a memory 704, a power supply component 706, a multimedia component 708, an audio component 710, an input/output (I/O) interface 712, a sensor component 714, and a communication component 716.

The processing component 702 typically controls the overall operation of the apparatus 700, such as operations associated with display, telephone call, data communication, camera operations, and recording operations. The processing component 702 may include one or more processors 720 to execute instructions to complete all or part of the steps of the above method. In addition, the processing component 702 may include one or more modules to facilitate interaction between the processing component 702 and other components. For example, the processing component 702 may include a multimedia module to facilitate interaction between the multimedia component 708 and the processing component 702.

The memory 704 is configured to store various types of data to support operations at the apparatus 700. Examples of these data include instructions for any application or method operating on the apparatus 700, contact data, phonebook data, messages, pictures, videos, etc. The memory 704 may be implemented by any type of volatile or nonvolatile storage device or their combinations, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or a compact disk.

The power supply component 706 provides power for various components of the apparatus 700. The power supply component 706 may include a power management system, one or more power sources and other components associated with generating, managing and distributing power for the apparatus 700.

The multimedia component 708 includes a screen providing an output interface between the apparatus 700 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, sliding and gestures on the touch panel. The touch sensor can not merely sense the boundary of the touch or sliding action, but also detect the duration and pressure related to the touch or sliding operation. In some examples, the multimedia component 708 includes a front camera and/or a rear camera. When the apparatus 700 is in an operation mode, such as a shooting mode or a video mode, the front camera and/or the rear camera can receive external multimedia data. Each front camera and rear camera can be a fixed optical lens system or have a focal length and optical zoom capability.

The audio component 710 is configured to output and/or input audio signals. For example, the audio component 710 includes a microphone (MIC) configured to receive an external audio signal when the apparatus 700 is in an operation mode, such as a call mode, a recording mode, and a speech recognition mode. The received audio signal may be further stored in the memory 704 or transmitted via the communication component 716. In some examples, the audio component 710 also includes a speaker for outputting the audio signal.

The I/O interface 712 provides an interface between the processing component 702 and a peripheral interface module which can be a keyboard, a click wheel, a button, etc. These buttons may include but are not limited to: a home button, volume buttons, a start button and a lock button.

The sensor component 714 includes one or more sensors for providing state evaluation of various aspects of the apparatus 700. For example, the sensor component 714 can detect an on/off state of the apparatus 700 and the relative positioning of the components, for example, the components are a display and a keypad of the apparatus 700. The sensor component 714 can also detect the change of the position of the apparatus 700 or one component of the apparatus 700, the presence or absence of user contact with the apparatus 700, the azimuth or acceleration/deceleration of the apparatus 700, and temperature change of the apparatus 700. The sensor component 714 may include a proximity sensor configured to detect the presence of nearby objects without any physical contact. The sensor component 714 may further include an optical sensor, such as a CMOS or CCD image sensor, for use in imaging applications. In some examples, the sensor component 714 may further include an acceleration sensor, a gyroscope sensor, a magnetic sensor, a pressure sensor, or a temperature sensor.

The communication component 716 is configured to facilitate wired or wireless communication between the apparatus 700 and other device. The apparatus 700 may access a wireless network based on a communication standard, such as WiFi, 2G or 3G, or their combinations. In an example, the communication component 716 receives a broadcast signal or broadcast-related information from an external broadcast management system via a broadcast channel. In an example, the communication component 716 further includes a near field communication (NFC) module to facilitate short-range communication. For example, the NFC module may be implemented based on a radio frequency identification (RFID) technology, an infrared data association (IrDA) technology, an ultra wideband (UWB) technology, a Bluetooth (BT) technology and other technologies.

In an example, the apparatus 700 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for performing the above method.

In an example, a non-transitory computer-readable storage medium including instructions, such as the memory 704 including instructions is further provided. The above instructions can be executed by the processor 720 of the apparatus 700 to complete the above method. For example, the non-transitory computer-readable storage medium may be an ROM, a random access memory (RAM), a CD-ROM, a magnetic tape, a floppy disk, optical data storage device, etc.

Other implementation solutions of the examples of the disclosure will be apparent to those skilled in the art from consideration of the specification and practice of the disclosure here. The present application is intended to cover any variations, uses, or adaptations of the examples of the disclosure following the general principles of the examples of the disclosure and including such departures from the disclosure as come within known or customary practice in the art. It is intended that the specification and examples be considered as examples merely, with a true scope and spirit of the examples of the disclosure being indicated by the following claims.

It will be appreciated that the examples of the disclosure are not limited to the exact construction that has been described above and illustrated in the accompanying drawings, and that various modifications and changes may be made without departing from the scope of the disclosure. It is intended that the scope of the examples of the disclosure merely be limited by the appended claims.

### INDUSTRIAL APPLICABILITY

In order to prevent interference caused by in-band emission, the user device excludes the time-frequency resource that may cause greater interference from available candidate time-frequency resources of the user device, that is, excludes the candidate time-frequency resource that has resource overlap with the second time-frequency resource. Since the second time-frequency resource is not the same time-frequency resource as the first time-frequency resource used by other user device, that is, more candidate time-frequency resources that may cause interference are excluded, the interference caused by the in-band emission can be reduced to a greater extent.

1. A method for determining a resource, performed by user device, comprising:
receiving sidelink control information, the sidelink control information indicating a first time-frequency resource; and
determining a candidate time-frequency resource to be excluded based on the sidelink control information;
wherein the candidate time-frequency resource to be excluded comprises a candidate time-frequency resource that has resource overlap with a second time-frequency resource, and the second time-frequency resource has resource overlap with the first time-frequency resource in a time domain, and has a different resource position from the first time-frequency resource in a frequency domain.

2. The method according to claim 1, wherein
the candidate time-frequency resource to be excluded further comprises a candidate time-frequency resource that has resource overlap with the first time-frequency resource.

3. The method according to claim 1, wherein the second time-frequency resource comprises at least one of the following:
a frequency-domain resource adjacent to the first time-frequency resource in the frequency domain; or
a frequency-domain resource at a mirror position of the first time-frequency resource in the frequency domain.

4. The method according to claim 1, wherein determining the candidate time-frequency resource to be excluded based on the sidelink control information, comprises:
acquiring a sidelink measurement value corresponding to the sidelink control information; and
determining the candidate time-frequency resource to be excluded that has resource overlap with the second time-frequency resource according to the sidelink measurement value and a first threshold value.

5. The method according to claim 4, wherein the first threshold value is greater than a second threshold value,
wherein the candidate time-frequency resource to be excluded that has resource overlap with the first time-frequency resource is determined according to the sidelink measurement value and the second threshold value.

6. The method according to claim 4, wherein the first threshold value is determined based on one of the following:
pre-defining the first threshold value;
pre-configuring the first threshold value; and
determining the first threshold value based on configuration or indication of a downlink signaling from network device.

7. The method according to claim 4, wherein the sidelink measurement value is a sidelink-reference signal receiving power (S-RSRP) measurement value or a received signal strength indication (RSSI) measurement value.

8. The method according to claim 4, further comprising:
determining a quantity of a target candidate time-frequency resource based on the candidate time-frequency resource to be excluded, wherein the target candidate time-frequency resource comprises a remaining candidate time-frequency resource after deleting the candidate time-frequency resource to be excluded from a candidate time-frequency resource set; and
determining an updated candidate time-frequency resource to be excluded, in a case that the quantity of the target candidate time-frequency resource is less than a set quantity threshold.

9. The method according to claim 8, wherein determining the updated candidate time-frequency resource to be excluded, comprises:
increasing the first threshold value by a set step size successively, determining the updated candidate time-frequency resource to be excluded in a case that the sidelink measurement value is greater than an increased first threshold value, and determining the quantity of the target candidate time-frequency resource based on the updated candidate time-frequency resource to be excluded until the quantity of the target_candidate time-frequency resource is greater than or equal to the set quantity threshold.

10. The method according to claim 8, wherein determining the updated candidate time-frequency resource to be excluded, comprises:
determining that the updated candidate time-frequency resource to be excluded merely comprises the candidate time-frequency resource that has resource overlap with the first time-frequency resource.

11. The method according to claim 1, wherein determining the candidate time-frequency resource to be excluded based on the sidelink control information, comprises:
the user device performing resource selection or resource reselection of a time-frequency resource for sidelink data transmission, determining the candidate time-frequency resource to be excluded.

12. The method according to claim 1, wherein determining the candidate time-frequency resource to be excluded based on the sidelink control information, comprises:
the user device performing inter-UE coordination (IUC) and determining a preferred or non-preferred resource set indicated by IUC information, determining the candidate time-frequency resource to be excluded.

13. The method according to claim 1, wherein determining the candidate time-frequency resource to be excluded based on the sidelink control information, comprises:
the user device performing sidelink data transmission in a shared spectrum by using an interlaced resource block, determining the candidate time-frequency resource to be excluded.

14. The method according to claim 1, wherein resource indication information or resource reservation information in the sidelink control information indicates the first time-frequency resource.

15. (canceled)

16. A communication apparatus, comprising:
a processor; and
a memory used to store processor-executable instructions, wherein
the processor-executable instructions stored in the memory, when executed by the processor, cause the processor to perform:
receiving sidelink control information, the sidelink control information indicating a first time-frequency resource; and
determining a candidate time-frequency resource to be excluded based on the sidelink control information;
wherein the candidate time-frequency resource to be excluded comprises a candidate time-frequency resource that has resource overlap with a second time-frequency resource, and the second time-frequency resource has resource overlap with the first time-frequency resource in a time domain, and has a different resource position from the first time-frequency resource in a frequency domain.

17. A non-transitory computer-readable storage medium, storing one or more programs configured to be executed by one or more processors of processing device, the one or more programs comprising instructions which, when executed by the processing device, causes the processing device to perform:
receiving sidelink control information, the sidelink control information indicating a first time-frequency resource; and
determining a candidate time-frequency resource to be excluded based on the sidelink control information;
wherein the candidate time-frequency resource to be excluded comprises a candidate time-frequency resource that has resource overlap with a second time-frequency resource, and the second time-frequency resource has resource overlap with the first time-frequency resource in a time domain, and has a different resource position from the first time-frequency resource in a frequency domain.

18. The communication apparatus according to claim 16, wherein
the candidate time-frequency resource to be excluded further comprises a candidate time-frequency resource that has resource overlap with the first time-frequency resource.

19. The communication apparatus according to claim 16, wherein the second time-frequency resource comprises at least one of the following:
a frequency-domain resource adjacent to the first time-frequency resource in the frequency domain; or
a frequency-domain resource at a mirror position of the first time-frequency resource in the frequency domain.

20. The communication apparatus according to claim 16, wherein the processor-executable instructions, when executed by the processor, cause the processor to further perform:
acquiring a sidelink measurement value corresponding to the sidelink control information; and
determining the candidate time-frequency resource to be excluded that has resource overlap with the second time-frequency resource according to the sidelink measurement value and a first threshold value.

21. The communication apparatus according to claim 20, wherein the first threshold value is greater than a second threshold value,
wherein the candidate time-frequency resource to be excluded that has resource overlap with the first time-frequency resource is determined according to the sidelink measurement value and the second threshold value.
